(19) United States
(12) Patent Application Publication
(10) Pub. No.: US 2024/0056106 A1
(43) Pub. Date: Feb. 15, 2024

(54) RF FRONT-END MODULE WITH BAND ISOLATION

(71) Applicant: SKYWORKS SOLUTIONS, INC., Irvine, CA (US)

(72) Inventors: Roman Zbigniew Arkiszewski, Oak Ridge, NC (US); John G. Freed, Raleigh, NC (US)

(21) Appl. No.: 18/229,207

(22) Filed: Aug. 2, 2023

Related U.S. Application Data
(60) Provisional application No. 63/396,348, filed on Aug. 9, 2022.

(51) Int. Cl. H04B 1/00

(52) U.S. Cl. CPC H04B 1/0057; H04B 1/0064

(57) ABSTRACT

An RF front-end module including a first transceiver unit, a second transceiver unit, a first antenna, a second antenna, a first diplexer, and a second diplexer. The first transceiver unit has a first transmitter and a first receiver and is configured to transmit at a first LTE 4G band, and the second transceiver unit has a second transmitter and a second receiver and is configured to transmit at a first new radio 5G (NR) band. The first antenna is connected via the first diplexer to the first transmitter and the first receiver, the first receiver being configured to receive at the first new radio 5G band, and the second antenna is connected via the second diplexer to the second transmitter and the second receiver, the second receiver being configured to receive at the first LTE 4G band.

### CROSS-REFERENCE TO RELATED APPLICATIONS

This application claims priority under 35 U.S.C. § 119(e) to U.S. Provisional Patent Application Serial No. 63/396,348, titled “RF FRONT-END MODULE WITH BAND ISOLATION,” filed Aug. 9, 2022, the entire content of which is incorporated herein by reference in its entirety for all purposes.

### BACKGROUND

### Field

Embodiments of the present disclosure relate to RF front-end modules with intermodulation product isolation, in particular radio frequency front-end modules with improved intermodulation product isolation between LTE and NR bands when working in a 4G/5G dual mode—EUTRAN New Radio Dual Connectivity (ENDC).

### DESCRIPTION OF THE RELATED TECHNOLOGY

In the transition from 4G to 5G networks it is necessary to have two transmitters operating simultaneously within a mobile handset. These transmitters form the RF front-end module. One transmitter operates in 4G mode and is used for control and signaling; the other transmitter operates in 5G mode and is used for data communication (ENDC operation). This is done to allow 5G services to be overlaid on existing 4G networks.

In most cases at least one of the transmitters is operating in full duplex mode, meaning that its receiver is operating at the same time as the transmitter. Operating two transmitters simultaneously leads to undesired interference between the two transmitted signals (intermodulation). Intermodulation products (IMD) generated from the mixing of two signals take the form of:

f_IMD=|A*f_TX1±B*f_TX2|

where f_IMD is the frequency of the intermodulation product, f_TX1 and f_TX2 are the frequencies of the transmitted signals, and A and B are integers. The order of the IMD product is the sum of A and B, with lower order products generally being higher amplitude than higher order products (i.e., 3rd order products are generally greater that 4^{th} order products, etc.)

Due to how the cellular frequency bands are allocated it is possible for the two transmit signals to produce an IMD product that falls directly on one of the wanted receive frequencies. Since the IMD product is generally much stronger than the wanted receive frequency it effectively reduces the sensitivity of the receiver at that frequency. This reduction in sensitivity due to the IMD signal falling on the receive channel is known as desensitization (desense). Desense is generally worse with lower IMD order.

Prior art RF front-end modules increase the receive signal level above the level of the IMD signal to maintain communication on the receive path and tend to suffer from reduced sensitivity (desense).

Further, current approaches to mitigating the effects of low order IMD falling on the receive channel include taking advantage of the allowed 3GPP specification relaxation, increasing power amplifier (transmitter) linearity to reduce the amount of IMD product generated, using notch filters to reject the unwanted transmitter leakage, and using separate modules for each transmitter.

Using the full specification relaxation does not reduce the desense. Lower desense is preferred and desense performance is often a key performance metric.

Boosting transmitter linearity can reduce the level of IMD generated to some extent. Increased linearity comes at the expense of current consumption. It is generally desirable to keep current consumption as low as possible because higher current consumption causes higher battery usage and lower battery life.

Notch filters placed at key locations within the module can reduce the unwanted transmitter leakage and IMD generated by the leakage. Notch filters cause loss at wanted frequencies however so the transmitter must produce more power to account for the loss which requires more current.

Using separate modules for each band improves the isolation between transmitters and generates lower IMD products. However, separate modules require more circuit board area in the customer's phone design and costs significantly more than a single module integrated approach.

### SUMMARY

According to one embodiment there is provided an RF front-end module comprising: a first transceiver unit, a second transceiver unit, a first antenna and a second antenna. The first transceiver unit has a first transmitter and a first receiver and is configured to transmit at a RF band according to a first communication protocol. The second transceiver unit has a second transmitter and a second receiver and is configured to transmit at a second RF band according to a second communication protocol. The first antenna is connected via a first diplexer-to the first transmitter and the first receiver, and the first receiver configured to receive at the second RF band. The second antenna is connected via a second diplexer to the second transmitter and the second receiver and the second receiver configured to receive at the first RF band.

By providing a pair of diplexers which filter different types of RF bands in one direction to the other, a much greater path for intermodulation products to propagate from one transmitter to a victim transmitter and then to the victim receiver is produced. This path has higher isolation than merely passing through a TX/RX filter. This means that the intermodulation product is much lower once it reaches the victim receiver, meaning that desense of the receiver is greatly reduced. Furthermore, the embodiment described achieves this reduction in desense without increasing current consumed by the RF front-end module and without increasing the space taken up by the RF front-end module.

In a further example the first RF band according to a first communication protocol is a 4G LTE band and the second RF band according to a second communication protocol is a 5G NR band.

In a further example, the first receiver is disposed adjacent the first transmitter, and in yet a further example the second receiver is disposed adjacent the second transmitter.

The route through the TX/RX filter in the prior art and discussed above is not the sole route from intermodulation products to pass from the victim transmitter to the victim receiver.

The intermodulation products can also propagate due to the proximity of the transmitter and receiver on the physical RF front-end module. By providing a separation, such that the victim transmitter is physically adjacent the other receiver, and the other transmitter is physically adjacent the victim receiver, this propagation route provides much higher isolation, such that the intermodulation product is negligible compared to the propagation path through the components of the RF front-end module.

In a further example the first transceiver unit, the second transceiver unit, the first diplexer and the second diplexer are disposed on a substrate. This allows for placement of the module within a mobile communication device and also ensures the physical separation of the components as discussed above.

In a further example the RF front-end module further includes a first switch configured to direct the first RF band from the first transmitter to the first diplexer. In a further example the first switch is further configured to direct the second RF band from the second transmitter to the second diplexer. The first switch allows for common connection of the transmitters to the circuit whilst also ensuring appropriate direction of the signal paths to the correct diplexer.

In a further example the RF front-end module further includes a second switch configured to direct the band from the first antenna to the first diplexer. In a further example the second switch is further configured to direct the first RF band from the second antenna to the second diplexer. The second switch allows for common connection of the antennae to the circuit whilst also ensuring appropriate direction of the signal paths to the correct diplexer.

In a further example the first RF band and the second RF band comprise a band pair. Additionally, the band pair is any one of the band pairs listed in table 1. The application is not limited to the exemplary band pair discussed in the description. Indeed, there are a large number of band pairs which, when propagated by an RF front-end module operating in an EN-DC mode, result in intermodulation products being imposed on one of the bands.

In a further example the first diplexer comprises a first transmission filter configured to pass the first RF band and a first reception filter configured to pass the second RF band. Additionally, the second diplexer comprises a second transmission filter configured to pass the second RF band and a second reception filter configured to pass the first RF band. By providing band pass filters it is ensured that out of band signals are not passed to the antennae or the receivers. Furthermore, the configuration of each diplexer allows for path separation and isolation of intermodulation products, as well as physical separation and isolation of intermodulation products, thus reducing receiver desense at the victim receiver.

In a further example the first and second transmission filter and the first and second reception filters are at least one of a SAW or a BAW filter. Additionally, the first and second transmission filter and the first and second reception filters may each comprise a plurality of SAW or BAW filters. SAW and BAW filters are easily tunable when they are manufactured by changing their physical parameters. And can be used independently or as part of a filter arrangement to provide the necessary out of band rejection for the RF bands of the RF front-end module.

In a further example, the RF front-end module also includes a third transceiver unit, a third diplexer and a third antenna. The third transceiver unit can include a transmitter and a receiver, and wherein the transmitter and receiver are physically separate from one another by at least one transmitter of at least one of the first or second transceiver unit. The inventive aspects set out above are scalable to provide further functionality, and can be used where intermodulation products are amplified or otherwise induced when transmitting a band “triplet”. These aspects can be extended to an arbitrary number of bands, where the IMD product generated by the transmitters falls into a desired receive band. As long as the physical separation is provided an improvement in desense at a victim receiver can be achieved.

According to another embodiment there is provided a method of reducing receiver desense in an RF front module operating in an EN-DC mode. The method includes transmitting from a first transceiver unit via a first diplexer a first RF band and receiving at the first transceiver unit via the first diplexer unit a second RF band. As set out above, diplexers which filter different types of RF bands in one direction to the other, provide a much greater path for intermodulation products to propagate from one transmitter to a victim transmitter and then to the victim receiver. This path has higher isolation than merely passing through a TX/RX filter. This means that the intermodulation product is much lower once it reaches the victim receiver, meaning that desense of the receiver is greatly reduced.

According to another embodiment there is provided a method of reducing receiver desense in an RF front-end module operating in an EN-DC mode. The method includes physically separating a first transmitter from a second receiver, wherein the first transmitter and the second receiver are configured to receive the same one of either an LTE 4G or NR 5G band, by at least one transmitter configured to transmit the other of the LTE 4G or NR 5G band. By providing a separation, such that the victim transmitter is physically adjacent the other receiver, and the other transmitter is physically adjacent the victim receiver, the propagation route due to physical proximity of the victim transmitter and receiver provides much higher isolation, such that the intermodulation product is negligible compared to the propagation path through the components of the RF front-end module.

According to another embodiment, a mobile communication device configured to operate in an EN-DC mode is provided which includes the RF frequency module according to any of the embodiments described above.

Mobile communication devices often need to operate in a 4G/5G mode (EN-DC mode) due to the sparse coverage of the 5G network. By providing a mobile device including the RF front-end module described above, the problem of sparse coverage of the 5G network is decreased, and furthermore, the mobile device can work more efficiently having the features and benefits set out above.

While the majority of the foregoing description refers to an EN-DC mode which is a 4G/5G mode, this disclosure is not limited as such, and the aspects defined herein relate to any dual mode transceiver RF front-end module where two transmitters are operating simultaneously and an IMD product is generated which falls within a passband of one of the associated receivers.

### BRIEF DESCRIPTION OF THE DRAWINGS

Various aspects of at least one embodiment are discussed below with reference to the accompanying figures, which are not intended to be drawn to scale. The figures are included to provide illustration and a further understanding of the various aspects and embodiments, and are incorporated in and constitute a part of this specification, but are not intended as a definition of the limits of the invention. In the figures, each identical or nearly identical component that is illustrated in various figures is represented by a like numeral. For purposes of clarity, not every component may be labeled in every figure. In the figures:

FIG. 1A shows a prior art RF front-end module.

FIG. 1B shows an IMD path on the prior art RF front-end module.

FIG. 2 shows an RF front-end module with improved IMD isolation.

FIG. 3 shows an IMD path on the RF front-end module with improved IMD isolation.

FIG. 4A shows a representation of a diplexer.

FIG. 4B shows a representation of a diplexer.

FIG. 5 shows a module comprising an improved RF front-end module.

### DETAILED DESCRIPTION

Aspects and embodiments described herein are directed to multi-chip modules, particularly front-end modules. In the following description, the term multi-chip module (MCM) and front-end module may be used interchangeably.

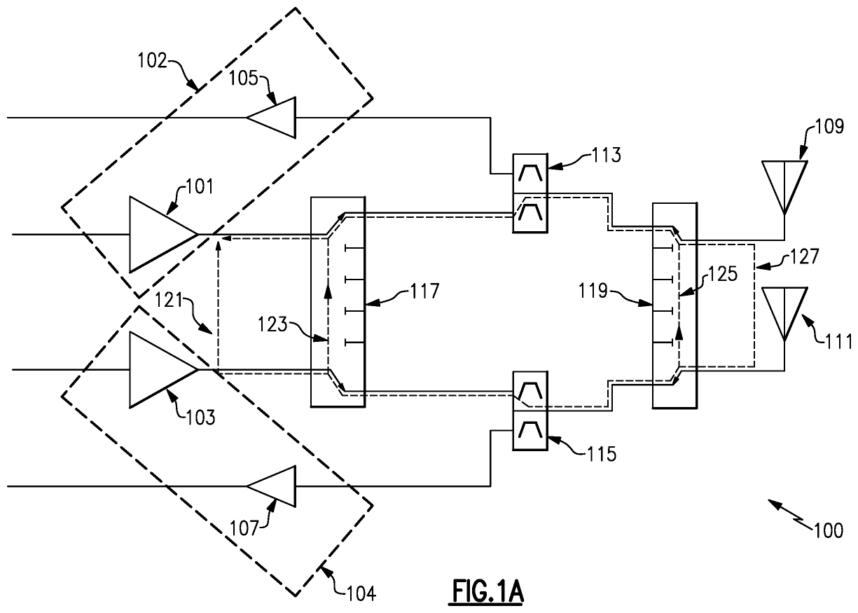

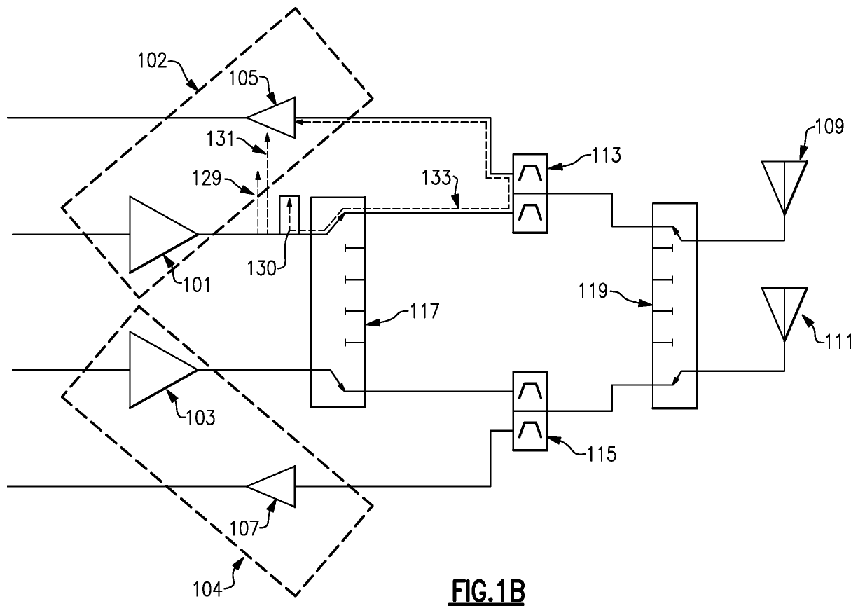

FIG. 1A shows a prior art RF front-end module 100. The RF front-end module 100 has a first transceiver unit 102 and a second transceiver unit 104. The first transceiver unit comprises a first transmitter 101 and a first receiver 105. In the RF front-end module 100 the first transceiver unit 102 is singularly configured to transmit and receive one radio frequency band, such as LTE band 1. That is, the first transmitter 101 is configured to transmit in one radio frequency band, such as LTE band 1, and the first receiver 105 is configured to receive the same radio frequency band, such as LTE band 1. The first transceiver 102 is not limited to LTE band 1, and may transmit or receive at any LTE or NR band.

Similarly, the second transceiver unit 104 comprises a second transmitter 103 and a second receiver 107. The second transceiver 104 is configured to transmit and receive in a second radio frequency band, such as NR band 3. That is, the second transmitter 103 is configured to transmit in one radio frequency band such as NR band 3, and the second receiver is configured to receive the same radio frequency band such as NR band 3. The second transceiver 104 is not limited to NR band 3 and may transmit and receive any LTE or NR band.

To transmit and receive signals each transceiver is communicatively coupled to an antenna. The first transceiver unit 102 is coupled to the first antenna 109, and similarly the second transceiver unit 104 is coupled to the second antenna 111.

Each transceiver unit is connected to its antenna via a respective TX/RX filter. The first transceiver unit 102 is connected to its antenna via a first TX/RX filter 113, and the second transceiver unit 104 is connected to its antenna via a second TX/RX filter 115. It will be appreciated that the first TX/RX filter 113 filters signals of the same radio frequency band.

The first TX/RX filter 113 comprises a transmission filter and a reception filter, where the transmission filter is a band pass filter configured to allow the prescribed radio frequency band to be transmitted from the first transmitter 101 to the antennas. The reception filter is a band pass filter set to the same band as the transmission filter, such that only the prescribed radio frequency band is passed back to the first receiver.

The second TX/RX 115 also filters signals of the same radio frequency band. The second TX/RX filter 115 comprises a transmission filter and a reception filter, where the transmission filter is a band pass filter configured to allow the prescribed radio frequency band to be transmitted from the second transmitter 103 to the antennas. The reception filter is a band pass filter set to the same band as the transmission filter, such that only the prescribed radio frequency band is passed back to the second receiver 107.

It will be appreciated that the first and second TX/RX filters are set to pass different radio frequency bands, for instance the first TX/RX filter 113 may pass LTE band 1 and the second TX/RX filter 115 may pass NR band 3.

Between the transmitters 101 and 103 and the TX/RX filters 113 and 115 is a first switch 117, which is configured to direct the signals appropriately from the first transmitter 101 to the first TX/RX filter 113 and from the second transmitter 103 to the second TX/RX filter 115. Further, between the antennas 109 and 111 and the TX/RX filters 113 and 115 is a second switch 119 which is configured to direct signals appropriately from the first antenna 109 to the first receiver 105 and from the second antenna 111 to the second receiver 107.

FIG. 1A also shows a set of pathways by which signals transmitted by the second transmitter 103 are inadvertently passed to the first transmission path and the first transmitter 101. The combination of these two signals, in the example of RF front-end module 100, causes a low order intermodulation product (IMD). The low order intermodulation product causes signal degradation to at least one of the bands, and this band is designated the “victim band”. There are a number of radio frequency band pairs, which if transmitted at the same time by the RF front-end module 100 produce low order intermodulation products which cause signal degradation to one or both of the bands. In most cases one band is more affected than the other, and this band is termed the victim band.

The above and following description use the specific example of LTE band 1 and NR band 3. The concept of LTE bands is well understood in the art, as is the concept of NR bands. The examples described herein however are not limited to LTE band 1 and NR band 3, and can apply to any band pair which produces an unwanted intermodulation product.

A non-exhaustive list of RF band pairs which produce intermodulation products is set out in Table 1 below. Since 3GPP specifications are continually evolving, there are likely to be additional band pairs with the same susceptibility to intermodulation products over time.

| LTE | NR | IMD | Victim |
|---|---|---|---|
| Band | Band | Order | Band |
| 1 | n3 | 3 | 1 |
| 1 | n77 | 2 | 1 |
| 2 | n66 | 3 | 2 |
| 2 | n46 | 3 | 2 |
| 2 | n78 | 2 | 2 |
| 3 | n1 | 3 | n1 |
| 3 | n5 | 2 | n5 |
| 3 | n77 | 2 | 3 |
| 3 | n78 | 2 | 3 |
| 5 | n3 | 2 | 5 |
| 5 | n7 | 3 | 5 |
| 5 | n38 | 3 | 5 |
| 5 | n66 | 2 | 5 |
| 5 | n13 | 3 | n13 |
| 5 | n13 | 3 | 5 |
| 7 | n5 | 3 | n5 |
| 7 | n20 | 3 | n20 |
| 7 | n40 | 3 | 7 |
| 8 | n20 | 3 | n20 |
| 8 | n20 | 3 | 8 |
| 8 | n41 | 3 | 8 |
| 13 | n5 | 3 | 13 |
| 13 | n5 | 3 | n5 |
| 13 | n71 | 3 | n71 |
| 20 | n7 | 3 | 20 |
| 20 | n8 | 3 | n8 |
| 20 | n8 | 3 | 20 |
| 20 | n41 | 3 | 20 |
| 21 | n79 | 3 | 21 |
| 25 | n66 | 3 | 25 |
| 25 | n66 | 3 | n66 |
| 26 | n41 | 3 | 26 |
| 28 | n50 | 2 | 28 |
| 40 | n7 | 3 | n7 |
| 41 | n20 | 3 | n20 |
| 41 | n8 | 3 | n8 |
| 41 | n26 | 3 | n26 |
| 50 | n28 | 2 | n28 |
| 66 | n25 | 3 | n25 |
| 66 | n25 | 3 | 66 |
| 66 | n2 | 3 | n2 |
| 66 | n5 | 2 | n5 |
| 66 | n46 | 3 | 66 |
| 71 | n13 | 3 | 71 |

Furthermore, although the description below exemplifies signal bleed from the second transmitter 103 to the first transmitter 101, this can of course happen in reverse. Although, the description below envisages the victim band being the band transmitted by the first transmitter 101, the victim band could also be the band transmitted by the second transmitter 103. For instance if the first transmitter 101 is an LTE (4G) band transmitter and the second transmitter 103 is a NR (5G) band transmitter

Pathway 121 is the direct transmission of the signal, e.g., NR band 3, transmitted by the second transmitter 103 to the signal path of the first transmitter 101, and into the first transmitter 101, which is also transmitting its own signal, e.g., LTE band 1. Pathway 123 is a route from the second transmitter 103 to the first transmitter 101 via the first switch 117. Pathway 125 is a route from the second transmitter 103 to the first transmitter 101 via the second switch 119. Finally, pathway 127 is a route via the antennas 109 and 111. Each route has a certain level of attenuation, which reduces the amount of intermodulation which interferes with the victim transmitter, the first transmitter 101. The pathways shown are the routes where the signal bleed is the least attenuated. Other pathways may occur due to the physical locations of the components in the RF front-end module, however these are unlikely to result in more damaging intermodulation products than the pathways shown, due to their higher attenuations.

FIG. 1B shows the two transmission signals from the first transmitter 101 signal path, as the band 3 transmission signal 129 and the band 1 transmission signal 131 as they propagate to the band 1 receiver, the first receiver 105 causing desense to the first receiver 105. Further, FIG. 1B shows the IMD 130 which is transmitted to the first receiver 105, causing desense to the first receiver 105. The IMD path 133 goes through the first TX/RX filter 113 and while the filter rejects the intermodulation product by a certain amount, a significant amount of the IMD passes through to the first receiver 105 causing desense.

In a specific example, the route through the first TX/RX filter is 58 dB, meaning that the IMD product loses 58 dB on the route from the band 1 transmitter to the band 1 receiver. This is still not sufficient to prevent desense of the band 1 receiver. As an example, for a third order IMD signal it would be acceptable to have approximately 70 dB loss in the path 133 to achieve minimal desense.

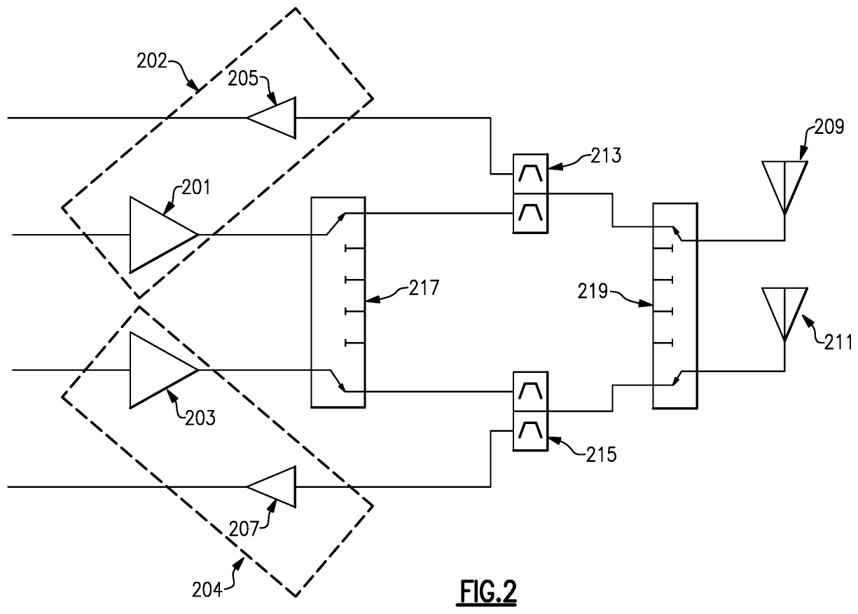

FIG. 2 shows an improved RF front-end module 200 according to the present disclosure. The improved RF front-end module comprises a first transceiver unit 202 having a first transmitter 201 and a first receiver 205, and a second transceiver unit 204 having a second transmitter 203 and a second receiver 207.

Similarly to the prior art RF front-end module 100 each transceiver unit is connected to its respective antenna 209 or 211. The first transmitter 201 and second transmitter 203 are connected to a first switch 217, and the first antenna 209 and 211 are connected to a second switch 219. However, between the first and second switches are a pair of diplexers 213 and 215 which replace the TX/RX filters or duplexers of the prior art front-end module 100.

In this context, a “diplexer” may be understood as a set of two or more filters configured to separate signals from one another, and a “duplexer” may be understood as a special case of a diplexer where the signals to be separated differ from each other by the duplex spacing. A diplexer may have no specific relationship between the passbands of the component filters.

The first transmitter 201 is connected through the first switch 217 to the second switch 219 via a first diplexer 213. The first diplexer 213 is configured to pass the first transmission signal from the first transmitter. In the illustrative example, as with FIG. 1A, this is band LTE band 1. In addition, the first antenna 209 is connected through the second switch to the first receiver 205 via the first diplexer 213. In this direction, a reception direction, the diplexer 213 is configured to pass the second reception signal, and in the illustrative example this is NR band 3.

This means that the first receiver 205 is configured to receive the second radio frequency band that the RF front-end module is configured to operate with. This means the first transceiver unit 202 is configured to transmit 4G and receive 5G signals. The band 3 receiver is therefore physically adjacent the band 1 transmitter.

Similarly, the second transmitter 203 is connected through the first switch 217 to the second switch 219 via a second diplexer 215. The second diplexer 215 is configured to pass the second transmission signal from the second transmitter. In the illustrative example, as with FIG. 1a, this is band NR band 3. In addition, the second antenna 211 is connected through the second switch to the second receiver 207 via the second diplexer 215. In this direction, a reception direction, the diplexer is configured to pass the first reception signal, and in the illustrative example this is LTE band 1.

This means that the second receiver 207 is configured to receive the first radio frequency band that the RF front-end module is configured to operate with. This means the second transceiver unit 204 is configured to transmit 5G and receive 4G signals. The band 1 receiver is therefore physically adjacent the band 3 transmitter.

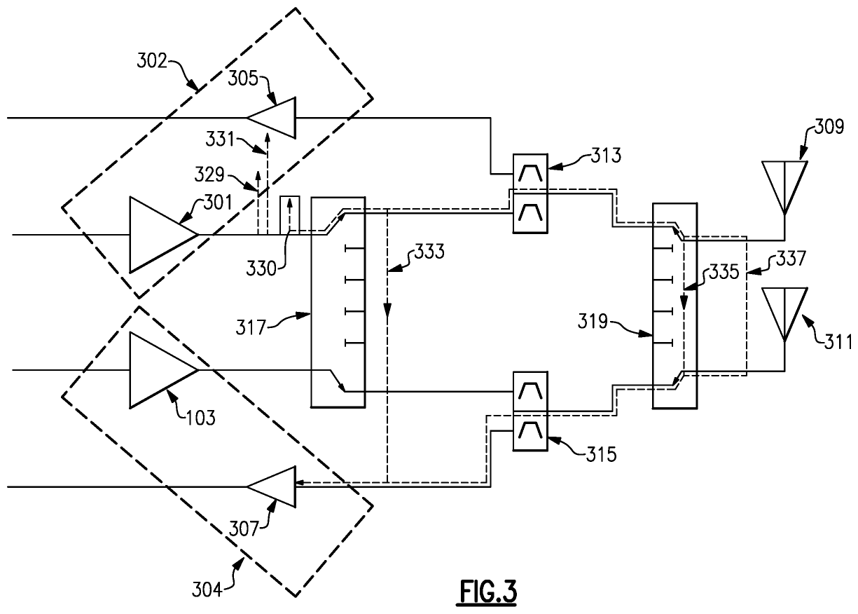

As will be appreciated, there is no longer a path through the first diplexer 213 for the IMD product to pass from the first transmitter 201 to the second receiver 207, which is now the band 1 receiver. Furthermore, there is no longer a direct path for the IMD from the band 1 transmitter to the band 1 receiver based on the proximity of the first transmitter 101 and the second receiver 107. There is also no longer a path through the second diplexer 215 for the IMD product to pass from the second transmitter 203 to the first receiver 205 or via the proximity of the transmitter and receiver. This will be discussed with greater detail with respect to FIG. 3.

In general, the RF front-end module 200 is arranged so that each transceiver unit comprises a transmitter configured to transmit at one band of the RF pair and a receiver configured to receive the other band. This means that physically the receiver and transmitter of the same band are separated, and the signal propagation route between each is greater with higher rejection.

FIG. 3 shows the resultant paths for the IMD product and demonstrates how the interference is much lower than in the prior art RF front-end module 100. There are three relevant paths for the IMD product from the first transmitter 301 to the second receiver 307. Firstly it can be seen that propagation due to the proximity of the components of the first transceiver unit 302 merely imposes the IMD product of the first and second transmitters onto the first receiver, which in this example is the NR band 3, and which is not the victim band of the RF pair.

This therefore removes this element of the IMD, and removes a certain level of desense from the first receiver 305.

Aside from this, there are three paths of concern for the IMD product to reach the second receiver 307. The first path 333 goes through the first switch 317 and the second diplexer 315. The isolation of this path is a sum of the diplexer isolation, which in this specific example is 58 dB as in the prior art RF front-end module 100, and the switch isolation which in this specific example is 38 dB. The total isolation for the path 333 is 95 dB.

The second path 335 goes through the band 1 transmit filter of the first diplexer 313, the second switch 319 and the band 1 receive filter of the second diplexer 315. The isolation is again the sum of these respective isolations, with the transmit filter isolation at 53 dB, the antenna switch isolation at 28 dB and the band 1 receive filter insertion loss 2 dB. The total isolation for path 337 is 83 dB.

The third path 337 goes through the band 1 transmit filter of the first diplexer 313, the second switch 319 through to the first antenna 309, across to the second antenna 311, through the second switch 319, and the band 1 receive filter of the second diplexer 315. With the transmit filter isolation at 53 dB, the antenna switch insertion loss at 1 dB, the antenna isolation at 12 dB, antenna switch insertion loss again at 1 dB and the band 1 receive filter insertion loss 2 dB, the total isolation for path 339 is 69 dB.

This means that the minimum isolation between the band 1 transmitter and the band 1 receiver is 69 dB. An improvement of 11 dB is therefore achieved over the prior art.

These values are purely exemplary and depend on the specific components of the circuit, however based on a comparison between a prior art RF front-end module 100 and the improved RF front-end module 200 using the same components, an improvement is clearly made.

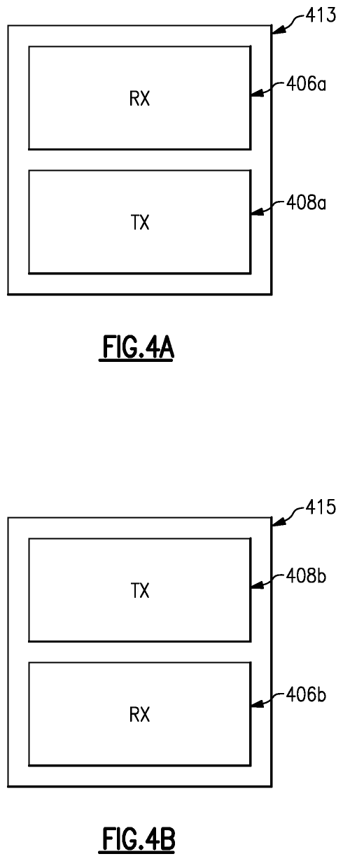

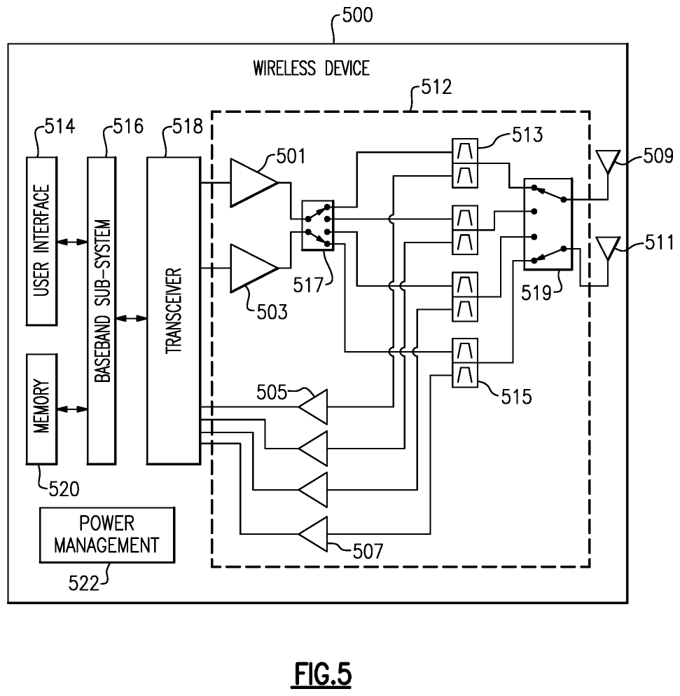

FIG. 4A shows a more detailed view of the first diplexer 313 as diplexer 413. The diplexer 413 comprises a first filter 406a and a second filter 408a. Each filter is a band-pass filter which is configured to pass a particular frequency band, and is tuned so that it passes the frequency band corresponding to the appropriate LTE or NR band and to reject frequencies outside the desired band. In particular, the first filter 406a is configured to pass the second RF band, that is signals in the frequency band corresponding to those transmitted by the second transmitter 303 which are then fed to the first receiver 305. The second filter 408a is configured to pass the first RF band, signals transmitted by the first transmitter 301, to which it is directly connected via the first switch 317.

The filters 406a and 408a may be surface acoustic wave (SAW) filters, or bulk acoustic wave (BAW) filters, or indeed a module comprising a number of SAW or BAW filters or a combination as required to achieve suitable out of band rejection and tuned to the appropriate frequency band.

Other components not shown within the first diplexer 313 may be a switch for directing incoming signals from the TX filter 408a to the first antenna 309 and for directing incoming signals from the first antenna 309 to the RX filter 406a. Signal processing components may also be present for pre or post-filtering of the RF signals.

FIG. 4B shows a more detailed view of the second diplexer 315 as diplexer 415. Similarly to the first diplexer 413 there is a first filter 406b and a second filter 408b, where in this case the first filter 406b is the TX filter and the second filter 408b is the RX filter. Again each filter is a band-pass filter which is configured to pass a particular frequency band, and is tuned so that it passes the frequency band corresponding to the appropriate LTE or NR band and to reject frequencies outside the desired band. In particular, the first filter 406b is configured to pass the second RF band, that is signals transmitted by the second transmitter 303 to which it is directly connected. The second filter 408b is configured to pass the first RF band, signals in the frequency band corresponding to those signals transmitted by the first transmitter 301, which are then fed to the second receiver 307.

The layout of the first and second diplexer is important for at least two reasons. Firstly, the diplexer is arranged so that physically on the RF front-end module the two receivers are located either side of the two transmitters. Due to the frequencies which the diplexers pass, the first receiver is adjacent the second transmitter and the second receiver is adjacent the first transmitter. This means that to pass the IMD product to the victim band there is a physical separation between the victim transmitter and the victim receiver, which provides sufficiently high isolation of the IMD product that it is no longer a concern for desense of the victim receiver.

Secondly, there is no longer a path from the victim antenna to the victim receiver for the IMD product to propagate which relies on the isolation of just one TX/RX filter. Instead there are now at least five components through which the intermodulation product must propagate to arrive at the victim receiver.

FIG. 5 shows an implementation of the RF front-end module 512 within a mobile or wireless device 500 in an embodiment. The RF front-end 512 comprises a transmit section and receive section. The transmit section includes one or more power amplifiers 501, 503 which amplify the transceiver 518 output to sufficient transmit power level, a band switch 517 which directs the power amplifier output to the appropriate band diplexer 513, 515; and an antenna switch 519 which directs the transmit signal to the appropriate antenna 509, 511. The receive section consists of an antenna 509, 511; the antenna switch 519 which directs the received signal to the appropriate diplexer 513, 515; and a low noise receive amplifier 505, 507 which amplifies the received signal prior to passing it on to the transceiver 518. The embodiment shown here comprises other signal paths for other signals, however the ENDC arrangement and the band pair are described with reference to the numerated elements of the front-end module.

In an embodiment using Band 1/Band 3 ENDC as an example, the Band 1 transmit signal from the transceiver 518 is amplified by the Band 1 power amplifier 501 and routed to the transmit section of diplexer 513 by the band switch 517, and then routed to Band 1 antenna 509 by antenna switch 519. Similarly, the Band 3 transmit signal from the transceiver 518 is amplified by the Band 3 power amplifier 503 and routed to the transmit section of diplexer 515 by the band switch 517, and then routed to the Band 3 antenna 511 by the antenna switch 519.

In receive mode, Band 1 signals are received by the antenna 511 and routed to the receive section of diplexer 515 by antenna switch 519. The receive output from diplexer 515 is routed to the Band 1 low noise amplifier 507 where it is amplified before being passed to the transceiver 518. Band 3 signals are received by antenna 509 and routed to the receive section of diplexer 513 by the antenna switch 519. The receive output from diplexer 513 is routed to the Band 3 low noise amplifier 505 where it is amplified before being passed to the transceiver 518.

The physical location of components in FIG. 5 do not reflect the actual location of components in the RF front-end module. In particular, it may be important, as discussed above, to achieve some separation between receive/transmit paths.

The RF front-end module is disposed in a wireless device 500 which comprises a memory 520 and a user interface 514. These are used to provide instruction to the baseband sub-system 516, which in turn provides and received signals to and from the transceiver 518. In addition, a power management module 522 is provided for the wireless device to control power for other systems of the device. The wireless device 500 is not limited to these components and may include other components for running other systems or subsystems of the device.

As explained above, the first RF band and the second RF band may comprise a band pair, which may be any one of the band pairs listed in Table 1 for example. However, although aspects of the present disclosure apply to the band pairs in Table 1, they are not restricted to just those band pairs as it is likely that evolution of 3GPP specifications and standards may create new band pairs that also have IMD issues. Aspects of the present disclosure can equally be applied to those yet to be determined bands.

Further, examples of the electronic devices in which aspects of this disclosure may be implemented include, but are not limited to, consumer electronic products, parts of the consumer electronic products such as packaged radio frequency modules, uplink wireless communication devices, wireless communication infrastructure, electronic test equipment, etc. Examples of the electronic devices can include, but are not limited to, a mobile phone such as a smart phone, a wearable computing device such as a smart watch or an ear piece, a telephone, a television, a computer monitor, a computer, a modem, a hand-held computer, a laptop computer, a tablet computer, a microwave, a refrigerator, a vehicular electronics system such as an automotive electronics system, a stereo system, a digital music player, a radio, a camera such as a digital camera, a portable memory chip, a washer, a dryer, a washer/dryer, a copier, a facsimile machine, a scanner, a multi-functional peripheral device, a wrist watch, a clock, etc.

It is to be appreciated that embodiments of the methods and apparatuses discussed herein are not limited in application to the details of construction and the arrangement of components set forth in the following description or illustrated in the accompanying drawings. The methods and apparatuses are capable of implementation in other embodiments and of being practiced or of being carried out in various ways. Examples of specific implementations are provided herein for illustrative purposes only and are not intended to be limiting. Also, the phraseology and terminology used herein is for the purpose of description and should not be regarded as limiting. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

Having described above several aspects of at least one embodiment, it is to be appreciated various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only, and the scope of the invention should be determined from proper construction of the appended claims, and their equivalents.

What is claimed is:

1. An RF front-end module comprising:
a first transceiver unit having a first transmitter and a first receiver and configured to transmit at a first RF band according to a first communication protocol;
a second transceiver unit having a second transmitter and a second receiver and configured to transmit at a second RF band according to a second communication protocol;
a first antenna connected via a first diplexer to the first transmitter and the first receiver, the first receiver configured to receive at the second RF band; and
a second antenna connected via a second diplexer to the second transmitter and the second receiver, the second receiver configured to receive at the first RF band.

2. The RF front-end module of claim 1 wherein the first RF band according to a first communication protocol is a 4G LTE band and the second RF band according to a second communication protocol is a 5G NR band.

3. The RF front-end module of claim 1 wherein the first receiver is disposed adjacent the first transmitter.

4. The RF front-end module of claim 1 wherein the second receiver is disposed adjacent the second transmitter.

5. The RF front-end module of claim 1 wherein the first transceiver unit, the second transceiver unit, the first diplexer and the second diplexer are disposed on a substrate.

6. The RF front-end module of claim 1 further comprising a first switch configured to direct the first RF band from the first transmitter to the first diplexer.

7. The RF front-end module of claim 6 wherein the first switch is further configured to direct the second RF band from the second transmitter to the second diplexer.

8. The RF front-end module of claim 6 further comprising a second switch configured to direct the second RF band from the first antenna to the first diplexer.

9. The RF front-end module of claim 8 wherein the second switch is further configured to direct the first RF band from the second antenna to the second diplexer.

10. The RF front-end module of claim 1 wherein the first RF band and the second RF band comprise a band pair.

11. The RF front-end module of claim 10 wherein the band pair is any one of the band pairs listed in table 1.

12. The RF front-end module of claim 1 wherein the first diplexer comprises a first transmission filter configured to pass the first RF band and a first reception filter configured to pass the second RF band.

13. The RF front-end module of claim 12 wherein the second diplexer comprises a second transmission filter configured to pass the second RF band and a second reception filter configured to pass the first RF band.

14. The RF front-end module of claim 13 where the first and second transmission filter and the first and second reception filters are at least one of a SAW or a BAW filter.

15. The RF front-end module of claim 14 wherein the first and second transmission filter and the first and second reception filters each comprise a plurality of SAW or BAW filters.

16. The RF front-end module of claim 1 further comprising a third transceiver unit, a third diplexer and a third antenna.

17. The RF front-end module of claim 16 wherein the third transceiver unit comprises a transmitter and a receiver, and wherein the transmitter and receiver are physically separate from one another by at least one transmitter of at least one of the first or second transceiver unit.

18. A mobile communication device configured to operate in an EN-DC mode, comprising the RF frequency module of claim 1.

19. A method of reducing receiver desense in an RF front module operating in an EN-DC mode, comprising transmitting from a first transceiver unit via a first diplexer a first RF band and receiving at the first transceiver unit via the first diplexer unit a first NR 5G band.

20. A method of reducing receiver desense in an RF front-end module operating in an EN-DC mode, comprising physically separating a first transmitter from a second receiver, the first transmitter and the second receiver being configured to receive the same one of either an LTE 4G or NR 5G band, by at least one transmitter configured to transmit the other of the LTE 4G or NR 5G band.
